(19) United States
(12) Patent Application Publication
(10) Pub. No.: US 2021/0033277 A1
(43) Pub. Date: Feb. 4, 2021

(54) Carbon-dioxide Supplier Safe and Without Hazardous Exhaust Gas

(71) Applicant: DAONRS Inc., Gwangju (KR)

(72) Inventors: Pil-Soo JEONG, Gwangju (KR); Dong-Uk PARK, Gwangju (KR)

(73) Assignee: DAONRS Inc.

(21) Appl. No.: 16/932,936

(22) Filed: Jul. 20, 2020

(30) Foreign Application Priority Data
Aug. 1, 2019 (KR) 10-2019-0094069

(51) Int. Cl. F23C 13/04; B01D 53/94; A01G 7/02; F23C 13/08; F23M 20/00; F23D 14/02; F23Q 3/00; F23N 5/24; F23C 3/00; B01J 23/86; B01J 35/04; C01B 32/50

(52) U.S. Cl. CPC F23C 13/04; B01D 2255/20784; A01G 7/02; F23C 13/08; F23M 20/00; F23D 14/02; F23Q 3/00; F23N 5/247; F23C 3/002; B01J 23/862; B01J 35/04; C01B 32/50; B01D 2255/70; B01D 2255/20738; B01D 2255/2092; B01D 53/944

(57) ABSTRACT

Disclosed is a combustion chamber (10) of the carbon dioxide supplier including: a combustion chamber (10) combusting a mixture of air and fuel; an air supply unit supplying an into the combustion chamber (10); and a fuel supply unit supply in a fuel to the combustion chamber (10). Representative Figure is FIG. 6.

### CROSS-REFERENCE TO RELATED APPLICATION

This application claims the benefit of priority to Korean Patent Application No. 10-2019-0094069 filed on Aug. 1, 2019, which are herein incorporated by reference in its entirety.

### TECHNICAL FIELD

The present invention relates to a carbon dioxide supplier that has excellent startability, is capable of complete combustion at a medium temperature and under ultra-lean conditions, and is safe.

### TECHNICAL BACKGROUND

In general, the speed of photosynthesis, which is required for growth when cultivating crops for high quality and high yield, is greatly affected by light intensity, temperature, and concentration of carbon dioxide (CO2).

Among them, the concentration of carbon dioxide is about 380 ppm in the atmosphere. Horticultural crops absorb carbon dioxide in the atmosphere during photosynthesis to produce photosynthetic products necessary for crop growth. As the photosynthetic products increase or decrease, the quantity and quality of crops are affected.

In other words, proper supply of carbon dioxide is one of the most important factors when growing horticultural crops.

However, since ventilation is very limited when growing crops in a housing facility in winter, the concentration of carbon dioxide in the housing facility decreases due to unidirectional consumption of carbon dioxide by photosynthesis in a dosed cultivation environment.

Accordingly, the concentration of carbon dioxide can be lower than the carbon dioxide gas payoff point of the crop. This serves as a limiting factor in the growth of the crop and thus poses a problem.

In view of the above-mentioned problems when cultivating a horticultural crop, conventionally, a method of supplying carbon dioxide has been used which employs a device that supplies liquefied carbon dioxide or a device that uses a combustor.

Among them, the device that supplies liquefied carbon dioxide directly supplies liquefied carbon dioxide into a greenhouse where crops are grown. Because liquefied carbon dioxide is expensive, it is disadvantageous in cost-effectiveness.

In addition, the conventional device that uses a combustor supplies exhaust gas generated from a combustion device, such as a boiler or an internal combustion engine, to a crop. Under the combustion system such as the above-described boiler or an internal combustion engine, is operated, fossil fuel combusts at a high temperature. Thereby, harmful exhaust gases generates such as NOx, HC (hydrocarbon), and CO (carbon monoxide), which interfere with photosynthesis and growth of crops.

The applicant has invented the carbon dioxide suppliers disclosed in Korean patents KR1652876B1 and KR1875526B1.

This devices combust carbon fuel at medium temperature under lean conditions by using a catalyst, thus significantly reducing harmful exhaust gases, such as NOx, HC, and CO.

However, the time from the initial ignition operation to a stable operation state (so-called warm-up time) is not short in the conventional carbon dioxide gas supplier. In addition, the overheat prevention structure of the conventional system is relatively complicated, and cannot physically block the heat of the ignited fuel-air mixture from being transferred to the fuel supply line (so-called back fire).

### DETAILED DESCRIPTION

### PROBLEMS TO BE SOLVED

The present invention has been devised to solve the above-described problems. An object of the present invention is to provide a carbon dioxide supplier that has a short warm-up time.

An object of the present invention is to provide a carbon dioxide gas supplier that has a simple overheating prevention structure and contributes to complete combustion.

An object of the present invention is to provide a carbon dioxide supplier that is safe from burn hazard and fuel explosion hazard.

### SOLUTION TO SOLVE THE PROBLEM

In order to solve the above-described problems, the present invention provides a carbon oxide gas supplier, and more specifically a carbon dioxide supplier, that generates carbon dioxide by combusting fuel.

The carbon dioxide supplier includes a combustion chamber (10) for combusting a mixture of air and fuel. The carbon dioxide supplier may further include an air supply unit supplying air to a combustion chamber (10) and a fuel supply unit supplying fuel to the combustion chamber (10). The combustion chamber (10) has an intake hole (111) on a first end (also referred to as as “one end”) and an exhaust hole (112) on a second end (also referred to as “the other end”).

In the chamber member, gas flows from the intake hole (111) to the exhaust hole (112). That is, the intake hole (111) is at the upstream of the gas flow in the chamber member, and the exhaust hole (112) is at the downstream of the gas flow in the chamber member.

In the chamber member (11), a first catalyst (12), a combustion space (114), and a second catalyst (14) are arranged in order along the direction of gas flow.

A mixing space (113) is provided at the upstream of the first catalyst (12), and the mixing space (113) may be provided inside the chamber member (11). The mixing space (113) provides ,a space in which air and gas are mixed. The air and the gas are respectively supplied from the air supply unit and the fuel supply unit into the chamber member (11) through the intake hole (111). An exhaust space (115) may be provided at the downstream of the second catalyst (14). The exhaust space (115) may he provided in the chamber member (11).

The first catalyst (12) is positioned in the chamber member (11) and at the downstream of the mixing space (113). The combustion space (114) is positioned at the downstream of the first catalyst (12) and in the chamber member (11). The second catalyst (14) is positioned at the downstream of the combustion space (114) and in the chamber member (11). An ignition device (13) may be positioned in the combustion space (114). The ignition device (13) can cause a spark to ignite the fuel-air mixture.

The fuel supply unit may include a fuel supply pipe (41). The fuel supply pipe (41) is positioned on the side where an intake hole (111) of the chamber is ember (11) is located. The fuel may be a gaseous fuel. The trajectory of the gas flow, defined by the, chamber member (11), may be straight. The gas may flow in a horizontal direction.

The first catalyst (12) may be a metal catalyst. The metal catalyst may be Fecralloy. The metal catalyst may be an alloy containing iron (Fe), chromium (Cr), and aluminum (Al). The cross section of the first catalyst (12) may correspond to the cross section of the flow of the chamber member (11). The first catalyst (12) may be stalled to contact an inner circumferential surface of the chamber member (11). Accordingly, the heat of the first catalyst (12) can be quickly conducted to the chamber member (11). The first catalyst (12) may be a porous structure with an expanded contact area. The porous structure is such structured that gas can flow through but flames cannot pass through.

The first catalyst (12) may be a form of foam. The first catalyst (12) may be a form of a honeycomb or a mesh. The pores of the first catalyst (12) may form a kind of adiabatic layer (porous). The ignition device (13) may be positioned closer'to the first catalyst (12) than to the second catalyst (14). The first catalyst (12) promotes an ultra-lean combustion reaction with an air-fuel ratio (λ) between 2.8 to 3.5. Thereby, it is possible to prevent the combustion temperature from rising excessively, thereby improving the initial startability and shortening the warm-up time.

The temperature at which the fuel-air mixture is combusted on a first end (also referred to as “one end”) of the first catalyst (12) may be 800 to 950 degrees Celsius. Preferably, the air-fuel ratio is about 3.0, and the combustion temperature may be 950 degrees Celsius. The closer the combustion temperature is to 950 degrees, the more the production of HC and CO can be suppressed. The combustion space (114) is positioned at the downstream of the first catalyst (12) along the gas flow. The first catalyst (12) physically blocks the flame from spreading towards the upstream of the gas flow, so that the reverse flow of the flame (so-called backfire) can be fundamentally prevented.

The second catalyst (14) may include a ceramic catalyst. The second catalyst (14) converts HC and CO, which are by-products of incomplete combustion in the first catalyst (12), into H2O and CO2. The second catalyst (14) can maintain at about 600 degrees Celsius. The cross section of the second catalyst (14) may correspond to the cross section of the chamber member (11). The second catalyst (14) may be installed to contact the inner circumferential surface of the chamber member (11). Accordingly, the heat of the second catalyst (14) can be quickly conducted to the chamber member (11).

The chamber member (11) may be a pipe. The intake hole (111) is provided on a first end of the pipe and the exhaust hole (112) is provided on a second end of the pipe. Specifically, the chamber member (11) may have a cylindrical shape. The carbon dioxide gas supplier may further include a housing (20) surrounding the combustion chamber (10).

The housing (20) may surround the outer periphery of the chamber member (11) and be spaced apart from the chamber member (11). The housing (20) isolates the chamber member (11) from the outside, but exposes the exhaust hole (112) to the outside.

The housing (20) includes: a chamber rover member (21) covering the chamber member (11) and spaced apart from the chamber member (11); an intake end member (22) that is connected to a first end of the chamber cover/member (21), is covering the intake hole (111), and is spaced apart from the intake hole (111) of the chamber member (11);

an exhaust end member (23) that is connected to a second end of the chamber cover member (21) and the second end of the chamber member (11), covers and blocks the space between the chamber member (11) and the chamber cover member (21), and exposes the exhaust hole (112) of the chamber member (11); and an air inlet port (24) connecting the outside of the housing (20) to a space between the chamber member (11) and the chamber cover member (21).

The air inlet (24) is coupled with the exhaust end member (23). In another embodiment, The air inlet (24) is coupled with the chamber cover member (21) in a position adjacent to the exhaust end member (23). The space spaced between the chamber member (11) and the chamber cover member (21) constitutes an air flow space (32) through which air introduced through the air inlet (24) flows. The air introduced through the air inlet (24) passes through the air flow space (32) and flows into the intake hole (111) of the combustion chamber (10). That is, the air inlet (24) may be positioned closer to the exhaust hole (112) than to the intake hole (111).

The air flow space (32) may include an outer space of the chamber member (11) corresponding to the first catalyst (12) and the second catalyst (14). The air in the air flow space (32) is heated by receiving heat from the chamber member (11) corresponding to the second catalyst (14), then further heated by receiving heat from the chamber member (11) corresponding to the combustion space (114), and then further heated by receiving heat from the chamber member (11) corresponding to the first catalyst (12).

The air flowing through the air flow space (32) absorbs heat from the chamber member (11) and is heated to about 60 to 80 degrees Celsius. The heated air promotes the combustion reaction of the ultra-lean mixture, and thereby promotes complete combustion. In addition, since air continuously flows in the air flow space (32) the degree of heat transfer from the chamber member (11) to the housing (20) can be further reduced. That is, the air flow space (32) and the air flowing through it function to block beat.

In the space between the chamber member (11) and the chamber cover member (21), a support frame (25) may be provided that connects and fixes the combustion chamber (10) and the housing (20). The support frame (25) may allow the air to flow from one end to the other end in a space between the chamber member (11) and the chamber cover member (21).

The fuel supply unit may include the fuel supply pipe (41) which penetrates through the fuel supply hole (211). The fuel supply hole (211) is equipped in the intake end member (22) and is fixed to the intake end member (22). The fuel supply pipe (41) may be connected to a fuel tank (2). The fuel tank (2) is connected to the carbon dioxide supplier (4) by a hose (3) and may be separated from the carbon dioxide supplier (4). For example, the carbon dioxide supplier may be installed in a greenhouse (1) to which carbon dioxide gas is supplied; and the fuel tank (2) is provided in a space separated from the greenhouse (1).

The air supply unit may include a fan (31) that induces air flow. The fan (31) may be provided at the air inlet (24). The fan (31) may be provided in the air flow space (32). The chamber cover member (21) may straightly extend in a direction parallel to the gas flow direction. The gas flow direction is defined by the chamber member (11).

### ADVANTAGES OF INVENTION

According to the present invention, since ultra-lean combustion is possible by the first catalyst, the combustion temperature of the fuel-air mixture can be lowered. Thus the production of NOx reduces and the production of HC and CO is minimized.

According to the present invention, since the filet-air mixture, which has passed through the first catalyst, is ignited on the downstream of the first catalyst, the initial startability is good and the warm-up process is rapid.

According to the present invention, the flame generated at the downstream of the first catalyst by the ignition device can be physically blocked from flowing back upstream to the first catalyst.

According to the present invention, since the air flow path for supplying the fuel-air mixture to the combustion chamber surrounds the chamber member, it is possible to minimize a transfer of the heat from the chamber member to the housing. In addition, the air can be sufficiently heated before being mixed with a fuel, thus promoting complete combustion.

According to the present invention, it is possible to prevent harmful gas emission and maximize the carbon dioxide gas production rate. This is accomplished by the second catalysis which completely post-treats HC and CO. The HC and CO are the by-products of the fuel-air mixture and generated due to incomplete combustion of the fuel-air mixture in the combustion space positioned at the downstream of the first catalyst.

In addition to the above-described effects, the concrete advantages of the present invention will be described in the following embodiments.

### BRIEF DESCRIPTION OF DRAWINGS

FIG. 1 is a perspective view of a carbon dioxide supplier according to an embodiment of the present invention when viewed from the exhaust end of the combustion chamber.

FIG. 2 is a perspective view of the carbon dioxide supplier of FIG. 1 when viewed from the intake end of the combustion chamber.

FIG. 3 and FIG. 4 are exploded perspective views of FIG. 1 and FIG. 2, respectively.

FIG. 5 and FIG. 6 are plan and cross-sectional views, respectively, of the carbon dioxide supplier shown in FIG. 1.

FIG. 7 is a carbon dioxide supplier according to the present invention which is installed in a greenhouse.

### EMBODIMENTS

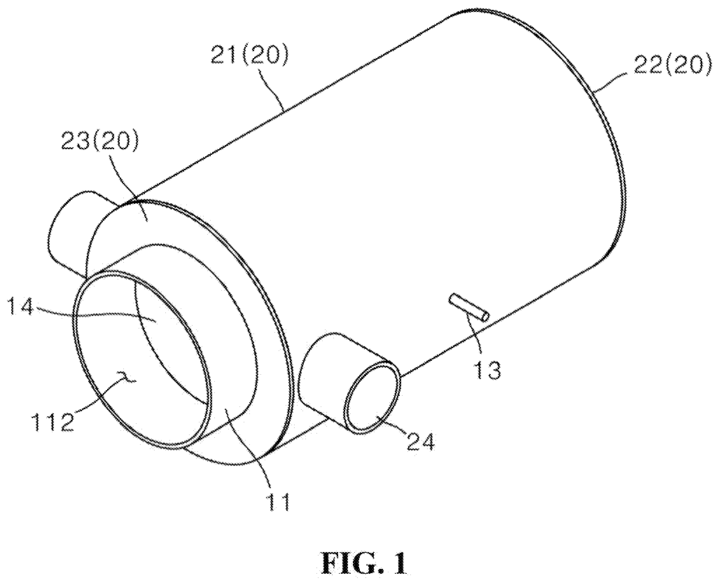

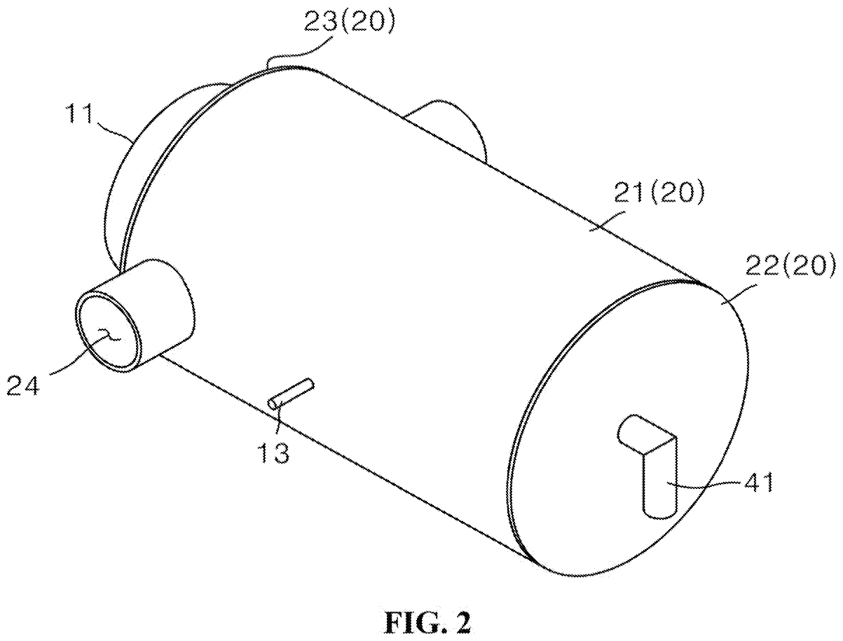

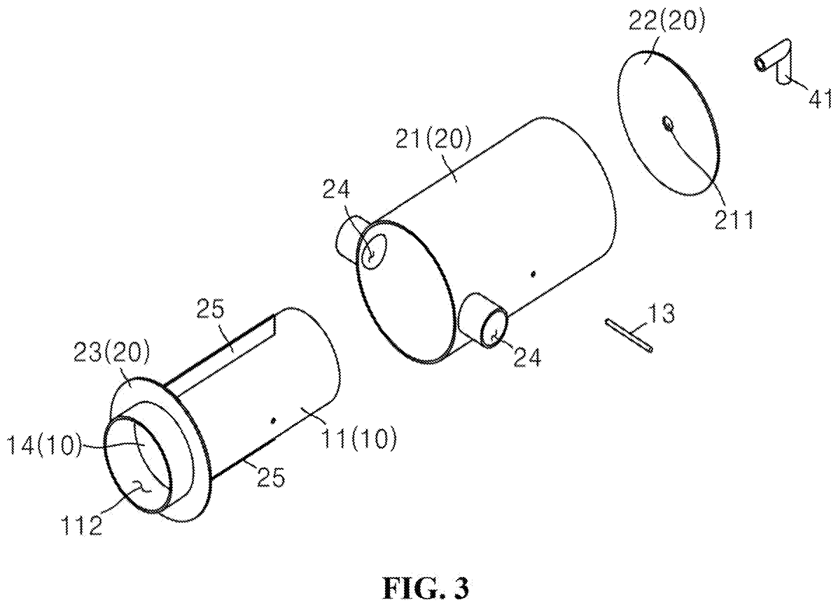

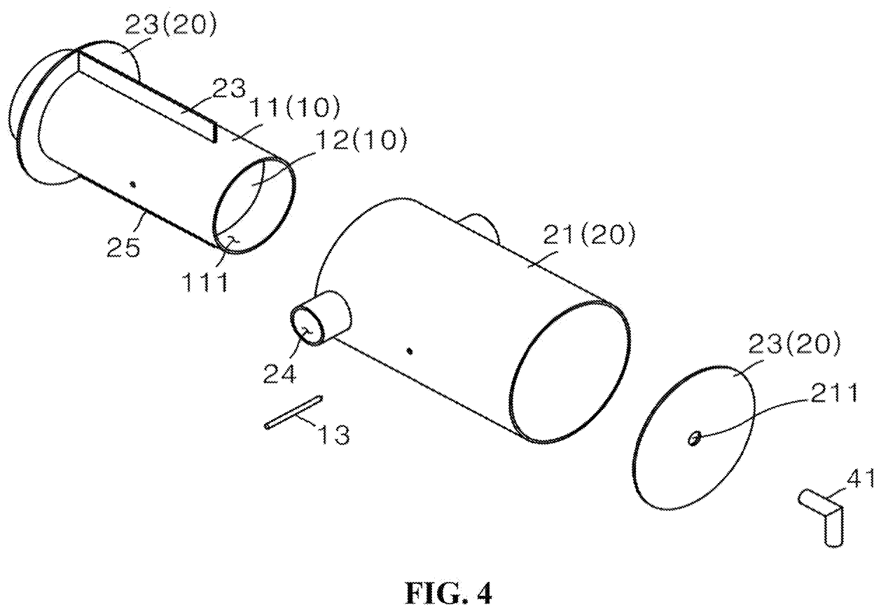

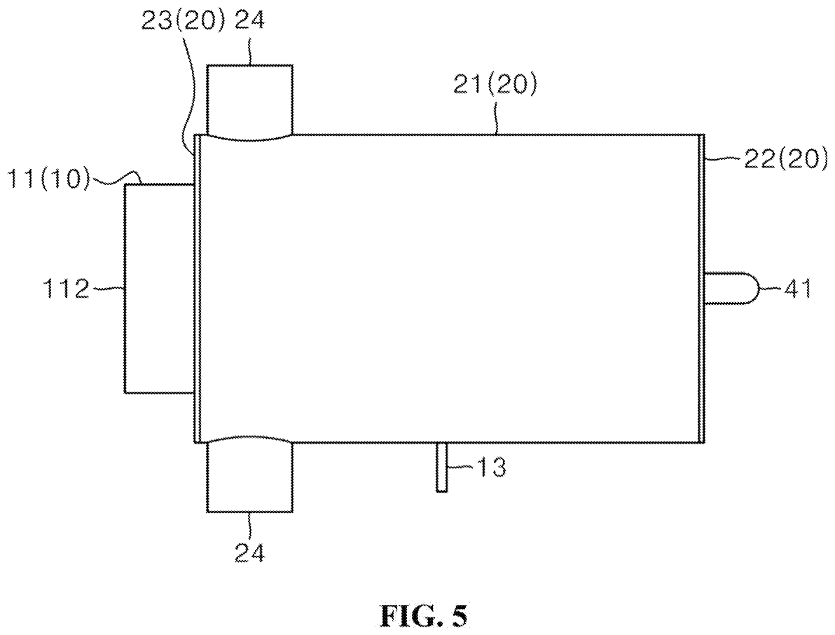

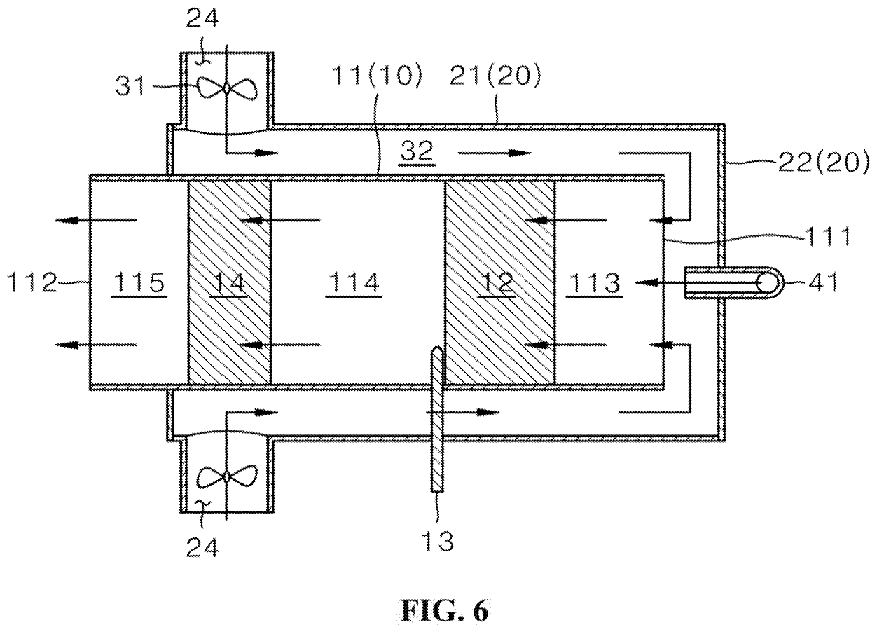

Hereinafter, a carbon dioxide supplier (4) according to an embodiment of the present invention will be described with reference to FIG. 1 to FIG. 6.

The carbon dioxide supplier (4) includes a combustion chamber (10) for combusting fuel, a housing (20) for protecting the combustion chamber, and an air supply unit and a fuel supply for supplying air and fuel, respectively, to the combustion chamber (10). The fuel combusted in the combustion chamber (10) may be such gas fuel as LPG and LNG. However, the present invention does not exclude the use of liquid fuels and solid fuels.

The housing (20) has a cylindrical shape that extends straight horizontally. The housing (20) includes a chamber cover member (21), an intake end member (22) provided at one end (also referred to as “first end”) of the chamber cover member (21), and an exhaust end member (23) provided at the other end (also referred to as “second end”) of the chamber cover member (21).

The chamber cover member (21) has a cylindrical shape. A hole is provided on a first side of the chamber cover member (21). An ignition device (13) passes through the hole. The intake end member (22) is a circular plate. A fuel supply hole (211) is provided at the center of the intake end member (22).

The fuel supply hole (211) is provided with a fuel supply pipe (41) constituting the fuel supply unit. The exhaust end member (23) is a round ring-shaped flat plate, through which the exhaust hole (112) of the combustion chamber (10) is exposed.

The combustion chamber (10) includes a chamber member (11) extending horizontally and straight. The chamber member (11) may be in a pipe or a cylindrical shape in which both ends are open. The one end (i.e., the first end) of the chamber member (11) constitutes an intake hole (111), and the other end (i.e., the second end) constitutes an exhaust hole (112).

That is, fuel and air may be introduced into the first end of the chamber member (11), be combusted inside, and then be discharged to the second end.

The direction in which the chamber member (11) extends defines the air flow path. The air flow path is the path along which a mixture of air and fuel is introduced into the intake hole (111) of the chamber member (11) and discharged to the exhaust hole (112). The chamber member (11) does not necessarily have to extend in a horizontally straight line. For example, in another embodiment, the chamber member (11) may extends in a vertically straight line, or in a beaded line.

The chamber cover member (21) may be spaced apart from the chamber member (11). Also, the chamber cover member (21) may be fixed to the chamber member (11). For example, the chamber cover member (21) and the chamber member (11) may be fixed together by a support frame (25), while being spaced apart from each other. The chamber cover member (21) may surround at least a portion of the chamber member (11) so that the chamber member (11) is not exposed to the outside. Accordingly, hazards, which may result when the chamber member (11) rises to a high temperature by combustion of the fuel-air mixture, can be prevented.

The chamber cover member (21) is extended to correspond to the extending direction of the chamber member (11). That is, the chamber cover member (21) has a shape corresponding to the chamber member (11), but may be larger in scale. In an embodiment, the chamber cover member (21) has the same cylindrical shape as the chamber member (11), but has a larger diameter than the chamber member (11) does. When the chamber member (11) has a bended shape as described above, the chamber cover member (21) also has such a shape as corresponding to this bended shape, but has a larger diameter or has larger bended shape overall.

The intake hole (111) provided on the first end of the chamber member (11) is exposed into the housing (20), but not exposed outside the housing (20). The intake end member (22) of the housing (20) is connected to the first end of the chamber cover member (21) to partition the housing (20) into an inner space and an outer space. However, the intake end member (22) of the housing (20) is spaced apart from the first end of the chamber member (11) at a predetermined distance. Therefore, the intake hole (111) provided on the first end of the chamber member (11) is connected to the interior space of the housing (20).

A fuel injection nozzle of the fuel supply pipe (41) is installed through the intake end member (22) and is positioned to face the intake hole (111) of the chamber member (11). The exhaust hole (112) provided on the second end of the chamber member (11) is exposed to the outside of the housing (20) through the exhaust end member (23).

The housing (20) is provided with an air inlet (24) that serves as a passage for introducing air from outside the housing into the housing. The air inlet (24) is provided on the second end of the housing (20). Multiple air inlets (24) may be provided at the second end of the chamber cover member (21) as shown.

The embodiment illustrates a structure in which two air inlets (24) are positioned opposite to each other with respect to the center of the housing. The air inlet (24) does not necessarily have to be positioned in the chamber cover member (21). The air inlet (24) may be positioned, for example, in the exhaust end member (23). A fan (31) may be installed at the air inlet (24) as an air supply unit. The fan (31) pressurizes the air outside the housing (20) as the fan (31) introduces the air into the housing (20).

The air introduced into the housing flows from the the second end of the carbon dioxide supplier (4) to the first end through an air flow space (32), which is a space between the chamber cover member (21) and the chamber member (11). Then, when the air hits the ii firer surface of the intake end member (22), the direction of air flow changes, and air flows into the chamber member (11) through the intake hole (111) of the chamber member (11).

Since the air flowing through the air flow space (32) flows as it absorbs the heat of the chamber member (11), the air blocks the heat of the chamber member (11) from being transferred to the chamber cover member (21) to some extent. In addition, the air flowing through the air flow space (32) increases in temperature by heat transferred from the chamber member (11). The air flow space (32) provides a route for air flow. Specifically, air flows back from the exhaust end of the chamber member (11) to the intake end in the housing (20), along the surface of the chamber member (11) along the direction in which the chamber member (11) extends.

The support frame (25) is positioned in the air ow space (32), but may be installed so as not to impede the gas flow in the air flow space (32).

The fan (31) is installed at a position so that the heat of the chamber member (11) affects the fan (31) as little as possible, so as to prevent the magnetic force of a magnet, which is installed inside the motor that drives the fan, from attenuating, and thereby ultimately maintaining the fan driving speed constant. Accordingly, it is possible to sufficiently secure the flow amount of air.

The fuel supply pipe (41) also injects gaseous fuel (i.e. gas) toward the intake hole (111) of the chamber member (11). Therefore, air and gas flowing from the intake hole (111) are mixed in the chamber member (11) to become a fuel-air mixture. The chamber member (11) guides the flow of the fuel-air mixture from the first end thereof to the second end thereof.

In the chamber member (11), the intake hole (111), a mixing space (113), the first catalyst (12), a combustion space (114), the second catalyst (14), an exhaust space (115), and the exhaust hole (112) are arranged in order from the first end to the second end of the chamber member (11). The mixing space (113) is a space in which fuel gas and air introduced through the intake hole (111) are mixed. Although not illustrated, a structure that promotes air and fuel to swirl may be further provided on the inner surface of the mixing space (113) of the chamber member (11). The swirl assists air and fuel to homogenize well.

The fuel-air mixture that has passed through the mixing space (113) then flows past the first catalyst (12). The first catalyst (12) may be a porous metal catalyst. The metal catalyst may be an alloy material containing 70 to 74 parts by weight of iron (Fe), 21 to 23 parts by weight of chromium (Cr), and 4 to 6 parts by weight of aluminum (Al).

The first catalyst (12) may be in a mesh shape or in a honeycomb form. The first catalyst (12) has an outer circumferential surface corresponding to the inner circumferential surface of the chamber member (11). That is, the first catalyst (12) may be installed to be in close contact with the inner circumferential surface of the chamber member (11). Under this structure, the fuel-air mixture cannot bypass the first catalyst (12), me fuel-air mixture may pass through the pores of the first catalyst (12) and contact the first catalyst.

The first catalyst (12) may lower the ignition temperature of the fuel or the threshold of the combustion temperature. In addition, the first catalyst (12) may have a high melting point such that it does not melt even when the temperature rises up to about 1400 degrees Celsius. The porous material of the first catalyst (12) may have a structure that allows the fuel-air mixture to pass, but does not allow flame to pass. The flame is generated from the fuel-air mixture combustion. That is, the first catalyst (12) may physically block the flame from propagating.

The fuel-air mixture that has passed through the first catalyst (12) flows into the combustion space (114). The combustion space (114) is full of the fuel-air mixture that have passed through the first catalyst (12). The combustion space (114) is provided with the ignition device (13) necessary for ignition of the fuel-air mixture. The ignition device (13) may be a spark igniter that uses high voltage to ignite spark. The ignition device (13) may be positioned in the combustion space (114) and adjacent to the first catalyst (12).

The fuel-air mixture that has passed through the first catalyst (12) begins to combust when ignited by the ignition device (13). Because a weak flame is maintained once ignited and combusted, the operation of the ignition device (13) is no longer necessary.

The fuel-air mixture that has passed through the first catalyst (12) is mainly combusted on the surface of the second end of the first catalyst (12), that is, the downstream surface of the air flow. On the surface of the second end of the first catalyst (12), a gentle yellow flame may occur. However, the flame is not transmitted back to the first end direction through the first catalyst (12).

The fuel-air mixture whose ignition point is lowered by the first catalyst (12) is, combusted while the temperature is maintained at about 800 to 950 degrees Celsius. Preferably, the combustion temperature may be maintained at about 950 degrees Celsius. Even during the initial ignition, the ignition temperature of the fuel-air mixture can be lowered by passing through the first catalyst (12). Thus, the startability is greatly improved.

The air-fuel ratio (λ) of the fuel-air mixture may be approximately between 2.8 to 3.5, preferably about 3, and may be in an ultra-lean state. The fuel-air mixture can be combusted even in an ultra-lean state by the first catalyst (12). Accordingly, the combustion temperature may not exceed 950 degrees Celsius. According to this embodiment, such medium temperature combustion can prevent release of NOx when the fuel-air mixture is combusted.

The gentle flame generated on the second end surface of the first catalyst (12) is not transmitted back to the first end through the first catalyst (12). That is, the first catalyst (12) functions as a barrier that physically blocks the flame from being transmitted toward the intake hole. Due to the ultra-lean combustion, some of the fuel-air mixture may not be completely combusted. This generates a gas such as HC or CO.

According to an embodiment, when the air of the fuel-air mixture flows through the outer circumferential surface of the chamber member, it absorbs heat of the chamber member and is provided into the chamber member in a heated state to constitute the fuel-air mixture. Therefore, it is possible to minimize the production of a gas such as HC or CO under the ultra lean combustion condition,

In addition, according to an embodiment, the second catalyst (14) is positioned downstream of the combustion space (114) to post-process HC and CO that are generated due to incomplete combustion in the combustion space (114). The second catalyst (14) may be a porous ceramic catalyst carrying ceramic on platinum (Pt). As the gas combusted in the combustion space (114) passes through the pores of the second catalyst (14), the BC Or CO that is part of the gas is completely combusted under the catalyst into CO2 and H2O. The second catalyst (14) is provided in a close contact with the inner circumferential surface of the chamber member (11), in order to prevent the combusted gas from bypassing the second catalyst (14).

The exhaust gas that is completely combusted through the second catalyst (14) contains CO2 and H2O. The exhaust gas goes to an exhaust space. The exhaust space is a space where the exhaust gas starts to come into contact with external air, and where water vapor molecules in the exhaust gas may condense.

There is a concern that the air inside the greenhouse (1) may become excessively humid when all the water vapor in the exhaust gas spreads inside the greenhouse (1). According to are embodiment of the present invention, the second end of the chamber member (11) extends beyond the end of the second catalyst (14) so that the second end of the chamber member (11) is exposed outside the housing (20). If necessary, the second end of the chamber member (11) may be cooled to condense the water vapor of the exhaust gas. The condensed water droplets may flow down the inner circumferential surface of the chamber member (11) which is exposed outside the housing.

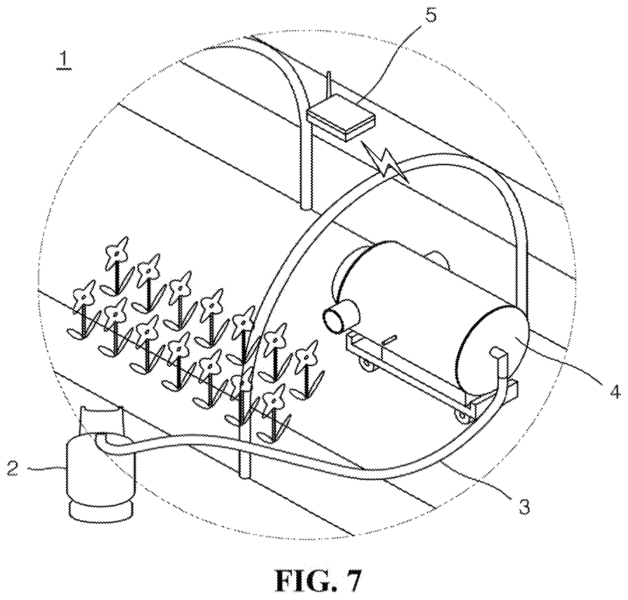

The carbon dioxide supplier (4) described above may be installed on a wagon or the like and is positioned in the greenhouse (1) as shown in FIG. 7. In addition, the carbon dioxide supplier may be horizontally positioned. The fuel supply pipe (41) may be connected to a fuel tank (2) through a long hose (3). The fuel tank (2) is installed outside the greenhouse (1) to prevent an explosion or the like. Since the carbon dioxide supplier has a simple structure, it is also possible to be installed on a ceiling of the greenhouse (1).

A controller (5) can be provided in the greenhouse (1) to control the operation of the carbon dioxide supplier (4). The controller (5) may measure, the temperature, humidity, and concentration of carbon dioxide in the greenhouse, and control the operation of the carbon dioxide supplier (4) based on such measurements made.

### Explanation of Symbols

1: greenhouse
2: fuel tank
3: hose
4: carbon dioxide supplier
5: controller
10: combustion chamber
11: chamber member
111: intake hole
112 exhaust hole
113: mixing space
114: combustion space
115: exhaust space
12: 1st catalyst, metal catalyst (foam)
13: igniter
14: second catalyst, ceramic catalyst (porous)
20: housing
21: chamber cover member
22: intake end member
211: fuel supply hole
23: exhaust end member
24: air inlet
25: support frame
31: fan
32: air flow space (heat insulation, intake heat)
41: fuel supply pipe

What is claimed is:

1. A carbon dioxide supplier that generates carbon dioxide by combusting fuel, comprising:
a combustion chamber (10) combusting a mixture of air and fuel;
an air supply unit supplying air into the combustion chamber (10); and
a fuel supply unit supplying fuel to the combustion chamber (10),
wherein the combustion chamber (10) comprises:
a chamber member (11);
an intake hole (111) provided at a first end of the chamber member (11) and located in an upstream of a as flow;
an exhaust hole (112) provided at a second end of the chamber member (11) and located in a downstream of the gas flow;
a mixing space (113) where air and fuel mix, wherein the air is supplied into the chamber member (11) through the intake hole (111), wherein the fuel is supplied into the chamber member (11) through the intake hole (111), wherein the mixing space (113) is provided inside the chamber member (11);
a first catalyst (12) positioned between the exhaust hole (112) and the mixing space (113);
a combustion space (114) positioned between the exhaust hole (112) and the first catalyst (12);
an ignition device (13) positioned inside the combustion space (114);
a second catalyst (14) positioned between the exhaust hole (112) and the combustion space (114); and
an exhaust space (115) positioned between the exhaust hole (112) and the second catalyst (14).

2. The carbon dioxide supplier of claim 1,
wherein the first catalyst (12) includes an alloy catalyst,
wherein the alloy catalyst includes iron (Fe), chromium (Cr), and aluminum (Al),
wherein the second catalyst (14) includes a ceramic catalyst.

3. The carbon dioxide supplier of claim 1,
wherein the first catalyst (12) includes a porous structure which has an extended contact area with gas, prevents a flame from passing through, and allows gas to flow through.

4. The carbon dioxide supplier of claim 1, further comprising:
a housing (20) surrounding the combustion chamber (10),
wherein the housing (20) comprises;
a chamber cover member (21) covering the chamber member (11) and spaced apart from the chamber member (11),
an intake end member (22) connected to a first end of the chamber cover member (21), covering the intake hole (111), and spaced apart from the intake hole (111) of the chamber member (11);
an exhaust end member (23) (i) connected to a second end of the chamber cover member (21) and the second end of the chamber member (11), (ii) enclosing a space between the chamber member (11) and the chamber cover member (21), and (iii) exposing the exhaust hole (112); and
an air inlet (24) connecting the space between the chamber member (11) and the chamber cover member (21) to communicate with outside of the housing (20).

5. The carbon dioxide supplier of claim 4,
wherein the air inlet (24) is (i) coupled with the exhaust end member (23) or (ii) coupled with the chamber cover member (21) in a position adjacent to the exhaust end member (23),
wherein the space spaced between the chamber member (11) and the chamber cover member (21) constitutes an air flow space (32) through which air introduced through the air inlet (24) flows,
wherein the air introduced through the air inlet (24) passes through the air flow space (32) and flows into the intake hole (111) of the combustion chamber (10).

6. The carbon dioxide supplier of claim 4, further comprising:
a support frame (25) provided in the space spaced between the chamber member (11) and the chamber cover member (21) and connecting and fixing the combustion chamber (10) and the housing (20),
wherein the support frame (25) allows air to flow from the air inlet (24) to the intake hole (111) in the space between the chamber member (11) and the chamber cover member (21).

7. The carbon dioxide supplier of claim 4,
wherein the fuel supply unit includes a fuel supply pipe (41),
wherein the fuel supply pipe (41) penetrates through the fuel supply hole (211) provided in the intake end member (22) and is fixed to the intake end member (22).

8. The carbon dioxide supplier of claim 4,
wherein a gas flow direction is defined by the chamber member (11) and is straight,
wherein the chamber cover member (21) extends straight in a direction parallel to the gas flow direction.

9. A carbon dioxide supplier that generates carbon dioxide by combusting fuel, comprising:
a combustion chamber (10) for combusting a mixture of air and fuel;
wherein the combustion chamber (10) includes:
a chamber member (11);
an intake hole (111) provided on a first end of the chamber member (11);
an exhaust hole (112) provided on a second end of the chamber member (11);
a first catalyst (12) positioned inside the chamber member (11);
a combustion space (114) positioned inside the chamber member (11) and located closer to the exhaust hole (112) than the first catalyst (12); and
a second catalyst (14) positioned inside the chamber member (11) and located closer to the exhaust hole (112) than the combustion space (114).

10. The carbon dioxide supplier of claim 9, further comprising:
an air supply unit supplying air to the combustion chamber (10); and
a fuel supply supplying fuel to the combustion chamber (10).

11. The carbon dioxide supplier of claim 9, further comprising:
a mixing space (113) provided in the combustion chamber (10) and mixing air and fuel supplied through the intake hole (111),
wherein the mixing space (113) is positioned closer to the intake hole (111) than the first catalyst (12).

12. The carbon dioxide supplier of claim 9, further comprising:
an ignition device (13) provided in the combustion space (114) and igniting a mixture of the fuel and the gas introduced through the first catalyst (12).

13. The carbon dioxide supplier of claim 9,
wherein the combustion chamber (10) further includes an exhaust space (115),
wherein the exhaust space (115) is positioned inside the chamber member (11) and located closer to the exhaust hole (112) than the second catalyst (14).

14. The carbon dioxide supplier of claim 9,
wherein the first catalyst (12) includes an alloy catalyst,
wherein the alloy catalyst includes iron (Fe), chromium (Cr), and aluminum (Al),
wherein the second catalyst (14) includes a ceramic catalyst.

15. The carbon dioxide supplier of claim 9,
wherein the first catalyst (12) includes a porous structure which has an extended contact area with gas, prevents a flame from passing through, and allows gas to flow through.

16. The carbon dioxide, supplier of claim 9,
wherein the chamber member (11) is a pipe,
whererin the intake hole (111) is provided on a first end of the pipe,
wherein the exhaust hole (112) is provided on a second end of the pipe. 17, The carbon dioxide supplier of claim 16,
wherein the chamber member (11) is in a cylindrical shape.

18. The carbon dioxide supplier of claim 9, further comprising:
a housing (20) surrounding the combustion chamber (10),
wherein the housing (20) surrounds an outer periphery of the chamber member (11) and is spaced apart from the chamber member (11).

19. The carbon dioxide supplier of claim 18,
wherein the housing (20) accommodates the chamber member (11) in a space separated from outside, and exposes the exhaust hole (112) to the outside.

20. The carbon dioxide supplier of claim 16,
wherein the housing (20) is provided with an air inlet (24),
wherein the air inlet (24) introduces air from outside of the housing (20) to the intake hole (111) of the chamber member (11),
wherein the air inlet (24) is positioned closer to tine exhaust hole (112) than the intake hole (111).
